(19) United States
(12) Patent Application Publication
(10) Pub. No.: US 2015/0147029 A1
(43) Pub. Date: May 28, 2015

(54) OPTICAL COMMUNICATION MODULE AND METHOD FOR ASSEMBLING SAME

(71) Applicant: HON HAI PRECISION INDUSTRY CO., LTD., NEW TAIPEI (TW)

(72) Inventors: I-THUN LIN, New Taipei (TW); YI HUNG, Tu-Cheng (TW)

(73) Assignee: HON HAI PRECISION INDUSTRY CO., LTD., New Taipei (TW)

(21) Appl. No.: 14/133,514

(22) Filed: Dec. 18, 2013

(30) Foreign Application Priority Data
Nov. 22, 2013 (TW) 102142543

(51) Int. Cl. G02B 6/32

(52) U.S. Cl. CPC G02B 6/32
USPC 385/33; 29/407.04

(57) ABSTRACT

An optical communication module includes a substrate, an optical-electric conversion unit located on and electrically connected to the substrate, and a lens unit. The lens unit includes a first surface facing the substrate and a second surface opposite to the first surface. The first surface includes a lens and defines two through holes extending from the second surface to the first surface. The lens is configured for coupling the optical-electric conversion unit to the lens unit. An optical axis of the lens is perpendicular to the substrate and on a first plane. Center lines of the two through holes are perpendicular to the substrate and on a second plane. The first plane is parallel with the second plane. The through holes are configured for aligning the lens with the optical-electric conversion unit.

### BACKGROUND

1. Technical Field

The present disclosure relates to an optical communication module and a method for assembling the optical communication module.

2. Description of Related Art

Optical communication devices include a substrate, light-emitting elements, a lens unit, and light-receiving elements. The light-emitting elements and the light-receiving elements are located on and electrically connected to the substrate. The lens unit is fixed on the substrate and configured for coupling the light-emitting elements and the light-receiving elements. The lens unit defines a lens on a surface facing the substrate.

After the light-emitting elements and the light-receiving elements are fixed on the substrate, the lens unit is needed to fix to the substrate to couple with the elements. Coordinates of the lens, the light-emitting elements, and the light-receiving elements must be determined. One sensor is used to determine the coordinate of the lens and another sensor is used to determine the coordinates of the light-emitting elements and the light-receiving elements. The coordinates are in different coordinate system so a conversion of coordinates is needed.

Therefore, it is desirable to provide an optical communication module and a method for assembling the optical communication module, which can overcome the limitation described.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is a schematic view of an optical communication module, according to an exemplary embodiment of the present disclosure.

FIG. 2 is an explored view of the optical communication module of FIG. 1.

FIG. 3 is a schematic view of a lens unit of the optical communication module of FIG. 1.

FIG. 4 is a schematic view of a method for assembling the optical communication module of FIG. 1.

### DETAILED DESCRIPTION

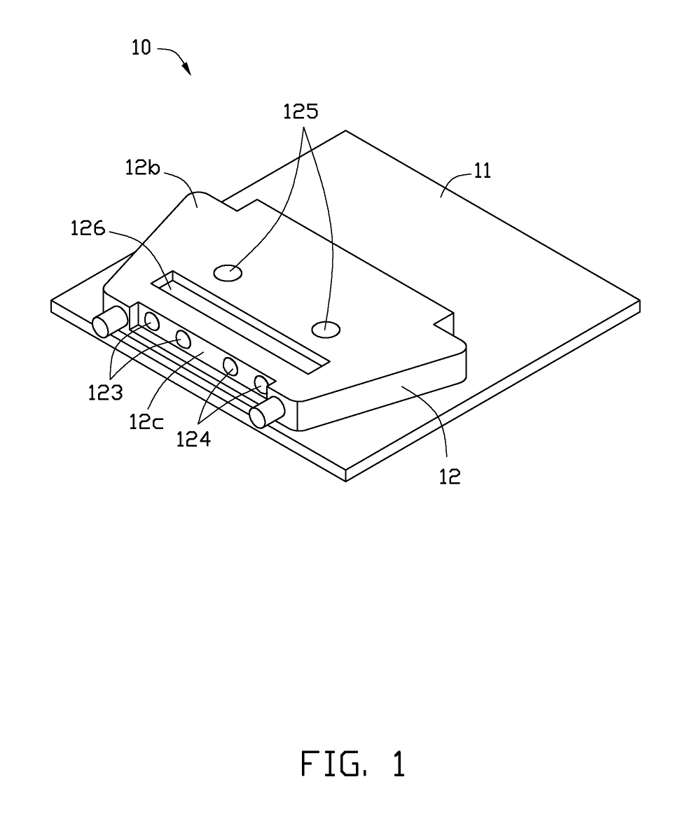

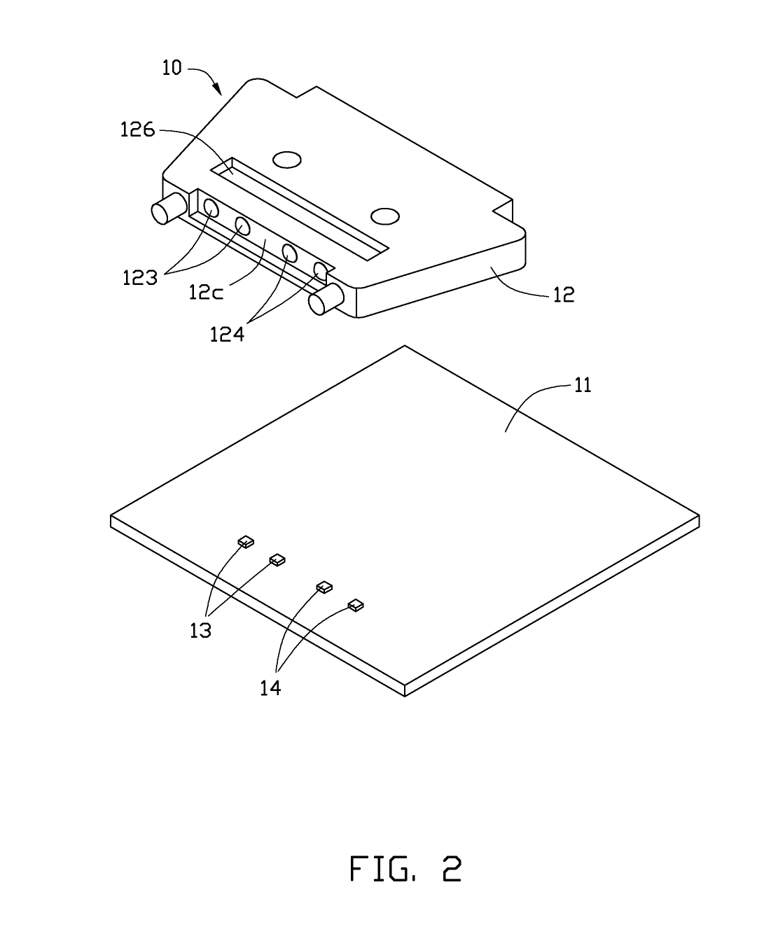

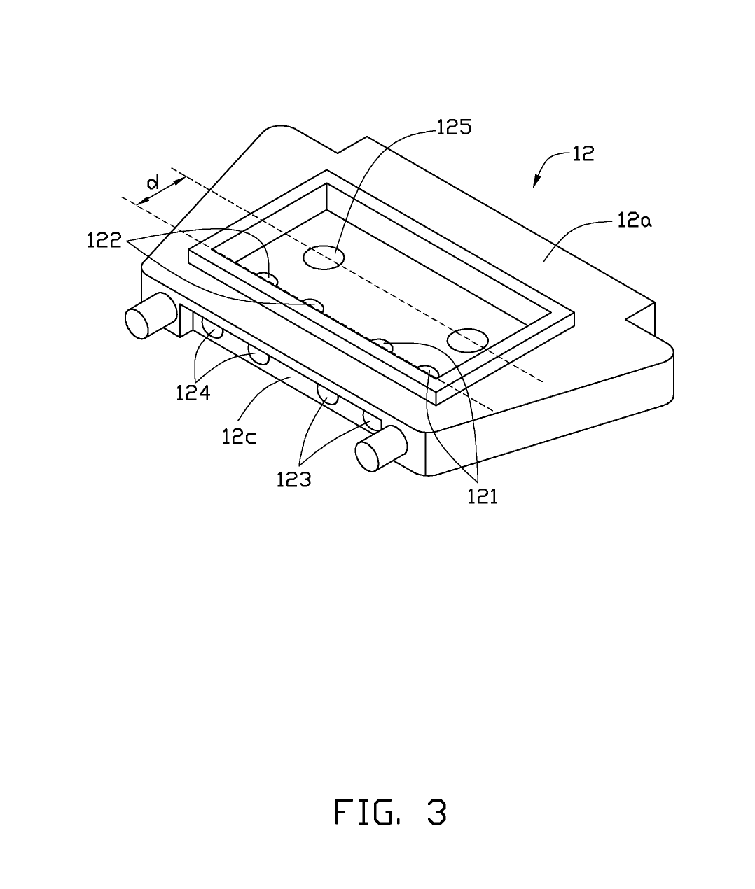

FIGS. 1-3 show an exemplary embodiment of an optical communication device 10. The optical communication device 10 includes a substrate 11, a lens unit 12, two light-emitting elements 13, and two light-receiving elements 14. The lens unit 12 is configured for coupling optical fibers (not shown) to the light-emitting elements 13 and the light-receiving elements 14.

The light-emitting elements 13 and the light-receiving elements 14 are collectively called optical-electric conversion units to achieve a conversion between optical signals and electric signals.

In other embodiments, the number of the light-emitting elements 13 and the light-receiving elements 14 can be one, three, or four, etc.

The light-emitting elements 13 and the light-receiving elements 14 are located on and electrically connected to the substrate 11. The light-emitting elements 13 are selected from the group consisting of light-emitting diodes and laser diodes. The light-receiving elements 14 are photo diodes. The lens unit 12 is fixed on the substrate 11 by glue or adhesive plaster.

The substrate 11 can be a circuit board, for example, a hard circuit board made by ceramic or a flexible circuit board.

The lens unit 12 includes a first surface 12a, a second surface 12b, and a third surface 12c. The first surface 12a faces and is parallel with the substrate 11. The second surface 12b is parallel with the substrate 11 and faces away from the substrate 11. The third surface 12c is perpendicular to the first surface 12a.

Two first lenses 121 and two second lenses 122 are defined on the first surface 12a. Optical axes of the first lenses 121 and the second lenses 122 are on a first plane P1 and are perpendicular to the substrate 11.

Two third lenses 123 and two fourth lenses 124 are defined on the third surface 12c. Optical axes of the third lenses 123 and the fourth lenses 124 are parallel with the substrate 11.

Two through holes 125 and a reflecting surface 126 extend from the second surface 12b to the first surface 12a. Center lines of the two through holes 125 are perpendicular to the substrate 11. Center lines of the two through holes 125 are on a second plane P2. The plane P1 is parallel with the plane P2 and a distance between the plane P1 and the plane P2 is d.

An included angel between the reflecting surface 126 and the optical axis of the first lens 121 is 45 degrees. An included angle between the reflecting surface 126 and the optical axis of the third lens 123 is also 45 degrees. The reflecting surface 126 reflects light 90 degrees.

When the lens unit 11 is fixed on the substrate 11, positions of the first lens 121 and the second lens 122 are determined according to the distance d. In other words, the through holes 125 are configured for locating the first lenses 121 and the second lenses 122.

A number of the first lenses 121 and a number of the third lenses 123 correspond to a number of the light-emitting elements 13. Arrangement of the first lenses 121 and arrangement of the third lenses 123 correspond to arrangement of the light-emitting elements 13. A number of the second lenses 122 and a number of the fourth lenses 124 correspond to a number of the light-receiving elements 14. Arrangement of the second lenses 122 and arrangement of the fourth lenses 124 correspond to arrangement of the light-receiving elements 14.

Light emitted by the light-emitting elements 13 is emitted onto the reflecting surface 126 through the first lenses 121. The light is reflected by the reflecting surface 126 onto the third lenses 123 and exits from the lens unit 12. Light emits onto the reflecting surface 126 through the fourth lenses 124. After the light is reflected by the reflecting surface 126 the light exits from the lens unit 12 through the second lens 122. The light-receiving elements 14 receive the light.

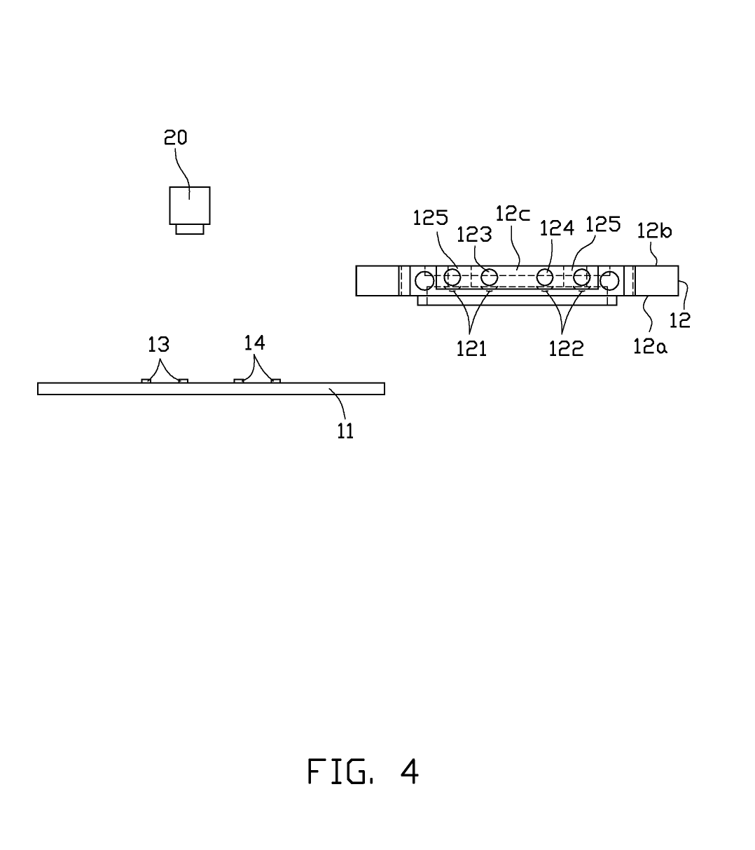

FIG. 4 shows that a method for assembling the optical communication module 10 is described as below.

The substrate 11 is fixed and then the light-emitting elements 13 and the light-receiving elements 14 are located on expected positions of the substrate 11.

A sensor 20 captures a first image of the light-emitting elements 13, the light-receiving elements 14, and the substrate 11. A first coordinate of one of the light-emitting elements 13 in a coordinate system is computed from the first image. X axis and Y axis of the coordinate system are two adjacent sides of the substrate 11.

The lens unit 12 is moved onto the substrate 11 and a second image of the lens unit 12 and the substrate 11 is obtained by the sensor 20. A second coordinate of one of the through holes 125 in the coordinate system is achieved from the second image. A difference between the first coordinate and the second coordinate is computed.

If the difference is equal to the distance d, the lens unit 12 is placed on a suitable position and then the lens unit 12 is fixed on the substrate 11.

If the difference is not equal to the distance d, the lens unit 12 keeps moving on the substrate 11. The sensor 20 captures another second image of the lens unit 12 and another second coordinate is obtained from the second image until the difference is equal to the distance d. Finally, the lens unit 12 is fixed on the substrate 11 with glue.

In other embodiments, the first coordinate of the light-receiving element 14 can be obtained from the first image.

The lens unit 12 includes two through holes 125 and the through holes 125 can be for locating the first lenses 121 and/or the second lenses 122. Position of the first lenses 121 is determined according to the position of the through holes 125. The first coordinate and the second coordinate are in same coordinate system of the substrate 11. There is no coordinate conversion between the first coordinate and the second coordinate.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely exemplary embodiments of the disclosure.

What is claimed is:

1. An optical communication module, comprising:
a substrate;
an optical-electric conversion unit located on and electrically connected to the substrate; and
a lens unit, wherein the lens unit comprises a first surface facing the substrate and a second surface opposite to the first surface, the first surface comprises a lens and defines two through holes extending from the second surface toward the first surface, the lens is configured for optically coupling the optical-electric conversion unit to the lens unit, an optical axis of the lens is perpendicular to the substrate and on a first plane, center lines of the two through holes are perpendicular to the substrate and on a second plane, the first plane is parallel with the second plane, the through holes are configured for aligning the lens with the optical-electric conversion unit.

2. The optical communication module of claim 1, wherein the lens unit comprises a third surface perpendicular to the substrate.

3. The optical communication module of claim 1, wherein a reflecting surface obliquely extends from the second surface towards the first surface.

4. The optical communication module of claim 3, wherein an included angel between the optical axis of the lens and the reflecting surface is 45 degrees.

5. The optical communication module of claim 1, wherein the optical-electric conversion unit is selected from the group consisting of a light-emitting element and a light-receiving element.

6. The optical communication module of claim 5, wherein the light-emitting element is selected from the group consisting of a light-emitting diode and a laser diode.

7. The optical communication module of claim 5, wherein the light-receiving is a photo diode.

8. The optical communication module of claim 1, wherein the substrate is selected from the group consisting of a hard circuit board and a flexible circuit board.

9. A method for assembling the optical communication module of claim 1, the method comprising:
locating the optical-electric conversion unit on expected position of the substrate;
obtaining a first image of the optical-electric conversion unit by a sensor;
computing a first coordinate of the optical-electric conversion unit on the substrate from the first image;
moving the lens unit onto the substrate;
obtaining a second image of the lens unit by the sensor;
computing a second coordinate of one of the through holes on the substrate from the second image of the lens unit;
analyzing the first coordinate and the second coordinate to obtain a difference between the first coordinate and the second coordinate;
comparing the difference to a distance between the first plane and the second plane; and
fixing the lens unit on the substrate if the difference is equal to the distance.

10. The method of claim 9, wherein the sensor is selected from the group consisting of CCD and CMOS.

11. The method of claim 9, wherein the lens unit is fixed on the substrate by glue.
